(19) United States
(12) Patent Application Publication
(10) Pub. No.: US 2025/0226166 A1
(43) Pub. Date: Jul. 10, 2025

(54) FUSE RELEASE MECHANISM

(71) Applicant: ABB SCHWEIZ AG, Baden (CH)

(72) Inventor: Aaron Motes, Ormond Beach, FL (US)

(21) Appl. No.: 18/409,463

(22) Filed: Jan. 10, 2024

(51) Int. Cl. H01H 37/08; H01H 37/04; H01H 37/76

(52) U.S. Cl. CPC H01H 37/08; H01H 37/04; H01H 37/761; H01H 2037/762

(57) ABSTRACT

A fuse release assembly includes a cap, the cap including a plate member, a first sidewall defining an interior region, and a plurality of first apertures extending through the first sidewall. The fuse release assembly includes an adapter, a release including a plurality of second apertures extending therethrough, a trigger, a biasing element, and a plurality of retention bodies. The fuse release assembly is configured to transition between a first and second state. In the first state, the release is arranged in a first position between the adapter and first sidewall such that the first apertures are colinearly aligned with corresponding second apertures, the plurality of retention bodies arranged in regions defined by the plurality of first apertures and second apertures, and the trigger and the biasing element are arranged in the interior region such that the trigger engages the retention bodies to retain the release in the first position.

### FIELD

The present disclosure relates to the field of electrical fuses, and more particularly, to a fuse release mechanism.

### BACKGROUND

Electrical systems often include safety devices that can provide overcurrent protection at a power line. With respect to at least some electrical systems, such safety devices can include electrical fuses. Traditionally, such fuses utilize an electrically conductive element through which electric current flows. In the event of an overcurrent condition, such as, for example, an electric current surge or overloading, the amount of electric current flowing through the fuse can melt a conductive element therein. Such melting of the conductive element interrupts the flow of current through the fuse and can result in the opening of the associated electric circuit. At least certain types of fuses can utilize an indicator element that can be displaced relative to the fuse so as to provide a visual indication that the fuse has been blown, and/or to provide a force to facilitate a triggering of the opening of an associated circuit. For example, the fuse can be installed in a fuse cutout assembly, and the indicator element can displace the fuse to electrically disconnect the fuse from the fuse cutout assembly.

### SUMMARY

Certain types of fuse releases can have a construction that can cause the indicator to interfere with the responsiveness of the fuse and/or that interrupt the capabilities of the fuse. Further, at least certain types of fuses, including fuses utilized in medium and/or high voltage applications, can include explosive powders, among other materials, that, when heated in response to an overcurrent condition, combust in a manner that generates an explosive force that can displace an indicator element. However, such explosive materials can present challenges with respect to at least shipping the associated fuses. Additionally, the performance of the explosive materials can at times be inconsistent, which can increase the potential for overcurrent conditions damaging other components of the electrical system.

Accordingly, although various types of electrical fuses are currently available in the marketplace, further improvements are possible to provide electrical fuses having striker elements that do not utilize explosive materials, and/or which assist in tripping an associated circuit without adversely impacting the responsiveness of the fuse to overcurrent conditions.

In some embodiments, a fuse release assembly includes a cap including a plate member, at least one first sidewall defining an interior region, and a plurality of first apertures extending through the at least one first sidewall; an adapter; a release including a plurality of second apertures extending therethrough; a trigger; a biasing element; a plurality of retention bodies; and the fuse release assembly is configured to transition between a locked state and an unlocked state. In some embodiments, in the locked state, the release is arranged between the adapter and the at least one first sidewall such that the plurality of first apertures are in colinear alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position.

In some embodiments, during the transition from the locked state to the unlocked state, the biasing element provides a spring force onto the trigger and onto the release to enable the release to move from the first position to a second position, the trigger and the biasing element being configured to apply the spring force onto the release such that a flange portion of the release engages the plurality of retention bodies and translates their position from the regions and into, at least in part, the interior region such that the release moves to the second position and enables at least a portion of the trigger to translate from the interior region to an exterior region.

In some embodiments, the trigger includes at least one recessed portion. In some embodiments, the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position.

In some embodiments, the cap further includes at least one second sidewall. In some embodiments, the at least one second sidewall is located opposite the plate member relative the at least one first sidewall and defines a recess. In some embodiments, the recess being configured to receive a fuse assembly such that the fuse release assembly, when installed into a fuse cutout assembly with the fuse assembly, places the fuse assembly in electrical engagement with the fuse cutout assembly.

In some embodiments, when installed in a lower hinge bracket of the fuse cutout assembly, the fuse release assembly transitioning to the unlocked state triggers the lower hinge bracket to pivotably displace the fuse release assembly and the fuse assembly to electrically disengage the fuse assembly from the fuse cutout assembly.

In some embodiments, the cap further includes an aperture. In some embodiments, the aperture extends through the plate member placing the interior region in fluid communication with the recess.

In some embodiments, the fuse release assembly further includes a filament. In some embodiments, the filament is configured to extend between the fuse assembly and the fuse release assembly through the aperture, the filament mechanically coupling a component in the fuse assembly to the trigger. In some embodiments, the filament is configured to retain the fuse release assembly in the locked state when the filament remains attached to the component in the fuse assembly. In some embodiments, in response to the filament mechanically decoupling from the component in the fuse assembly, enables the fuse release assembly to transition to the unlocked state.

In some embodiments, the release includes at least one third sidewall. In some embodiments, the plurality of second apertures extend through the at least one third sidewall.

In some embodiments, the adapter further includes at least one fourth sidewall. In some embodiments, the at least one fourth sidewall includes one or more threads disposed on an inner surface of the adapter, the one or more threads being configured to engage one or more threads of the at least one first sidewall to retain the adapter in position around the at least one first sidewall and the release.

In some embodiments, a system includes a fuse assembly; a fuse release assembly including a cap, a release, an adapter, a trigger, a biasing element, and a plurality of retention bodies; and a filament. In some embodiments, the filament extends between and mechanically couples a component of the fuse assembly to the trigger located in an interior region of the cap. In some embodiments, in response to the filament mechanically decoupling the trigger from the component in the fuse assembly, the fuse release assembly is configured to transition from a locked state to an unlocked state and trigger a lower hinge bracket of a fuse cutout assembly to pivotably displace and electrically disengage the fuse assembly from the fuse cutout assembly.

In some embodiments, the fuse cutout assembly includes an upper hinge bracket, and the lower hinge bracket; and the fuse assembly is installed into the fuse cutout assembly between the upper hinge bracket and the lower hinge bracket. In some embodiments, the fuse release assembly is configured to be arranged in the lower hinge bracket between the fuse assembly and the fuse cutout assembly, the fuse release assembly being further configured to place the fuse assembly in electrical engagement with the fuse cutout assembly.

In some embodiments, the cap includes a plate member, at least one first sidewall defining the interior region, at least one second sidewall defining a recess, and a plurality of first apertures extending through the at least one first sidewall. In some embodiments, the release includes a plurality of second apertures, and a flange portion. In some embodiments, the trigger includes at least one recessed portion.

In some embodiments, in the locked state, the release is arranged between the adapter and the at least one first sidewall such that the plurality of first apertures are in colinearly alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position. In some embodiments, during the transition from the locked state to the unlocked state, the biasing element provides a spring force onto the trigger and onto the release to enable the release to move from the first position to a second position, the trigger and the biasing element being configured to apply the spring force onto the release such that the flange portion of the release engages the plurality of retention bodies and translates their position from the regions and into, at least in part, the interior region such that the release moves to the second position and enables at least a portion of the trigger to translate from the interior region to an exterior region.

In some embodiments, the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position.

In some embodiments, the at least one first sidewall extends from the plate member and towards a first end to define the interior region; the at least one second sidewall extends from the plate member and towards a second end to define the recess, the recess being configured to receive the fuse assembly; and the plate member further includes an aperture placing the interior region in fluid communication with the recess.

In some embodiments, the release includes at least one third sidewall, and the plurality of second apertures extends through the at least one third sidewall.

In some embodiments, the adapter further includes at least one fourth sidewall including one or more threads disposed on an inner surface of the adapter, and the one or more threads of the adapter are configured to engage one or more threads of the at least one first sidewall to retain the adapter in position around the at least one first sidewall and the release.

In some embodiments, a device includes a cap including a plate member including an aperture extending therethrough, at least one first sidewall located on a first side of the plate member, the at least one first sidewall defining an interior region, a plurality of first apertures extending through the at least one first sidewall, and at least one second sidewall located opposite the plate member relative the at least one first sidewall, the at least one second sidewall defining a recess; an adapter; a release including at least one third sidewall, and a plurality of second apertures extending through the at least one third sidewall; a trigger; a biasing element, the biasing element is located between the plate member and the trigger; and a plurality of retention bodies. In some embodiments, the device is configured to transition between a locked state and an unlocked state. In some embodiments, in the locked state, the release is arranged between the adapter and the at least one first sidewall such that the plurality of first apertures are in colinearly alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position. In some embodiments, during the transition from the locked state to the unlocked state, the biasing element provides a spring force onto the trigger and onto the release to enable the release to move from the first position to a second position, the trigger and the biasing element being configured to apply the spring force onto the release such that a flange portion of the release engages the plurality of retention bodies and translates their position from the regions and into, at least in part, the interior region such that the release moves to the second position and enables at least a portion of the trigger to translate from the interior region to an exterior region, to enable the device to electrically disengage a fuse assembly from a fuse cutout assembly.

In some embodiments, the trigger includes at least one recessed portion, the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position. In some embodiments, the adapter further includes at least one fourth sidewall, the at least one fourth sidewall includes one or more threads disposed on an inner surface of the adapter, the one or more threads of the adapter being configured to engage one or more threads of the at least one first sidewall to retain the adapter in position around the at least one first sidewall and the release.

In some embodiments, the device further includes a filament, the filament is configured to extend between a component in the fuse assembly and the trigger through the aperture, the filament mechanically coupling the component in the fuse assembly to the trigger, the filament is configured to retain the device in the locked state when the filament remains attached to the component in the fuse assembly, and in response to the filament mechanically decoupling from the component in the fuse assembly, enables the device to transition to the unlocked state and electrically disengage the fuse assembly from the fuse cutout assembly.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a perspective view illustrating a system, according to some embodiments.

FIG. 2 is a first perspective view illustrating a fuse release of FIG. 1, according to some embodiments.

FIG. 3 is a second perspective view illustrating the fuse release of FIG. 1, according to some embodiments.

FIG. 4 is an exploded side view illustrating the fuse release of FIG. 1, according to some embodiments.

FIG. 5 is a side perspective view illustrating the fuse release, according to some embodiments.

FIG. 6 is a sectional side view illustrating the fuse release, according to some embodiments.

FIG. 7 is a flow diagram of a method for manufacturing the fuse release, according to some embodiments.

### DETAILED DESCRIPTION

Various embodiments of the present disclosure relate to systems, devices, and apparatuses for a fuse release mechanism. The fuse release mechanism may also be referred to as a fuse indicator, fuse release, fuse release assembly, and the like, and which may be known to those having ordinary skill in the art. The fuse release mechanism may include a cap, a trigger, a tensioning element, and a release body. The trigger and the tensioning element may be arranged, in some embodiments, in an interior region of the cap, the interior region being defined by at least one sidewall. In addition, the release body may be positioned in the fuse release such that at least one sidewall of the release body is arranged around a periphery of the at least one sidewall of the cap.

The fuse release may also include an adapter, the adapter being positioned around a periphery of the release body. The adapter may be configured to connect to the cap by one or more threads on an inner surface of the adapter engaging one or more threads on an outer surface of the at least one sidewall of the cap. The adapter may also be configured to retain a plurality of retaining bodies in the fuse release, as will be further described herein. In some embodiments, the adapter may also assist in retaining a position of the release body such that movement of the release body along a relative radial direction is limited.

The cap in the fuse release may include a plate member, the at least one sidewall extending from a first side of the plate member and defining the interior region, and at least one sidewall extending from a second side of the plate member and defining a recess. The plate member may also include an aperture extending through the plate member such that the interior region is placed in fluid communication with the recess. The fuse release may be configured to be installed onto a fuse assembly (e.g., fuse) such that the end of the fuse is installed in the recess.

A connecting element (e.g., filament) may be installed between a conductive element of the fuse at a first end and the trigger in the interior region of the fuse release at a second end, the connecting element extending through the aperture in the plate member to mechanically couple the conductive element and the trigger. During an initial installation of the fuse release onto the fuse, the connecting element may be configured to extend between and connect the conductive element located in the fuse with the trigger located in the fuse release. In addition, the connecting element may be tensioned such that the fuse release is in a first state (or locked state). In the first state, the connecting element may apply a compressive force onto the trigger and the biasing element, thereby causing the biasing element to compress such that the trigger is fully positioned in the interior region, or at least flush with the opening surface of the interior region, such as to enable the release to be positioned along an axial direction of the fuse release such that apertures in the at least one sidewall of the cap and defining the interior region is in colinear alignment with apertures in the at least one sidewall of the release body. With the trigger in this locked or tensioned position where the apertures in the sidewall defining the interior region are colinearly aligned with the apertures in the release, the trigger body may engage the retention members such that they are positioned in a region defined by the apertures in the sidewall of the cap and the apertures in the sidewall of the release body.

When an overcurrent or surge condition occurs in the fuse, or some other event that mechanically decouples the connecting element from the conductive element in the fuse and causing the fuse release to transition from the first or locked state to a second or unlocked state. During the transition from the first state to the second state, the tension (e.g., compressive force) being applied onto the trigger and the biasing element by the connecting element are released, thereby enabling the biasing element to apply an opposing biasing force between the trigger and a bottom surface of the interior region. The biasing element thereby causing the trigger to transition from its position located in the interior region and to move in an axial direction opposite the fuse towards an external region relative the interior region of the cap. In this regard, during the transition from the first state to the second state, the trigger engages the release body, and the trigger and biasing element applies the spring force onto the release body to promote translation of the release body from a first position and in the axial direction opposite the fuse towards a second position. In some embodiments, during the translation from the first or locked state to the second or unlocked state, at least a portion of the trigger may translate from the interior region and to the exterior region relative the interior region. In other embodiments, at least a portion of the biasing element may translate from the interior region and to the exterior region relative the interior region such that the trigger is substantially located in the exterior region.

As the release body translates in the axial direction outwards away from the fuse and towards the second position, a flange located on an inner surface of the release body sidewall engages the retention bodies and translates the position of the retention bodies from the regions defined by the corresponding apertures in the sidewall of the cap and the corresponding apertures in the sidewall of the release body and into, at least in part, the interior region to enable the biasing force applied onto the trigger by the biasing element to translate the trigger to move in the axial direction and to cause the release body to translate to the second position such that the fuse release is in the second state. The first position may be such that the release body is fully seated onto the at least one sidewall defining the interior region of the cap, in some embodiments. In other embodiments, the first position may be such that the release body is substantially seated onto the at least one sidewall defining the interior region of the cap. In addition, the second position may be such that the release body is ejected from the cap in an axial direction opposite the fuse by a certain distance to cause the fuse assembly and the fuse release, when installed into a fuse release assembly, to pivotably displace a hinge bracket to electrically disengage the fuse assembly from the fuse cutout assembly, as will be further described herein.

In this regard, the trigger may include a shape configured to, when the trigger is in the locked position, engage the retention bodies and position the retention bodies in the apertures of the cap sidewall and the apertures in the release body. The trigger may also include a shape configured to accommodate, at least in part, the retention bodies when the retention bodies are translated into the interior region, that is, the trigger may include a recessed portion circumferentially extending around an intermediate portion of the trigger, the recessed portion being configured to accommodate the retention bodies when causing the release body to move from the first position to the second position in response to the bias force from the biasing element when the trigger is mechanically decoupled from the conductive element in the fuse.

In various embodiments, a system may include a fuse release and a fuse. The fuse release may be installed on an end of a fuse (e.g., fuse assembly), such that a connecting element mechanically couples the conductive element in the fuse with the trigger in the fuse release. The system may also include an electrical cutout assembly in electrical connection with an electrical circuit. The electrical cutout assembly may include an upper hinge bracket and a lower bracket.

The fuse may be installed in the fuse cutout assembly such that an end of the fuse is positioned in a sleeve of the upper hinge bracket and the other end of the fuse having the fuse release installed thereon being positioned in a sleeve of the lower hinge bracket. In response to a surge or electrical overcurrent event melting the conductive element in the fuse, the trigger in the fuse release mechanically decouples from the fuse and causes the fuse release to transition from a first state to the second state, thereby causing to release body to move to the second position. The lower hinge bracket may be attached to the fuse release at the release body at one end and pivotably attached to a body of the fuse cutout assembly at the other end such that when the release body moves to the second position, the release body causes the lower hinge bracket to pivotably displace the fuse and electrically disengage the fuse assembly from the fuse cutout assembly.

In various embodiments of the present disclosure, the components of the fuse release may have an improved design compared to conventional fuse releases, thereby improving the overall reliability of the fuse release's operation as a result of the simplistic design over the conventional indicators. The improved design reduces a likelihood of failure due to malfunction of the one or more parts of the fuse release during a surge or overcurrent condition. For example, the one or more embodiments of the fuse release may include a single biasing element therein applying the biasing force onto the trigger and that enables the release body to move from the first position to the second position in response to the trigger mechanically decoupling from the conductive element in the fuse.

In addition, when the fuse release and the fuse are installed into a fuse cutout assembly, the biasing element in the fuse release may be configured to act in cooperation with one or more external forces when the fuse release triggers the lower hinge bracket, to enable the lower hinge bracket to become pivotably displaced and to disconnect the fuse from the upper hinge bracket so that the fuse is electrically disengaged from the fuse cutout assembly and the electrical circuit.

The improved design of the fuse release and the components therein may be manufactured to include a smaller form factor compared to conventional indicators, the one or more embodiments of the fuse release described herein including sizes and dimensions that enable the fuse release to be compatible with smaller sizes of fuses compared to other conventional indicators. The improved design and smaller form factor also provides the benefit of decreasing the amount of electrically conductive material that may be needed to manufacture the components of the fuse release, thereby reducing the overall costs to manufacture the fuse release and providing a more compact form factor. The smaller form factor of the various embodiments described herein enable the design and installation of fuse cutout assemblies having smaller total dimensions into electrical systems and locations where weight and size constraints are limitations and that the larger conventional fuse cutout assemblies configured for the larger form factor fuses and fuse releases may not be suitable. That is, the conventional fuse releases include designs that utilize, for example, multiple spring elements therein to initiate the fuse indication. Although certain conventional fuse releases may include a smaller form factor similar to the one or more embodiments described herein, these conventional indicators typically include an explosive medium therein instead of the springs to cause the indication.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

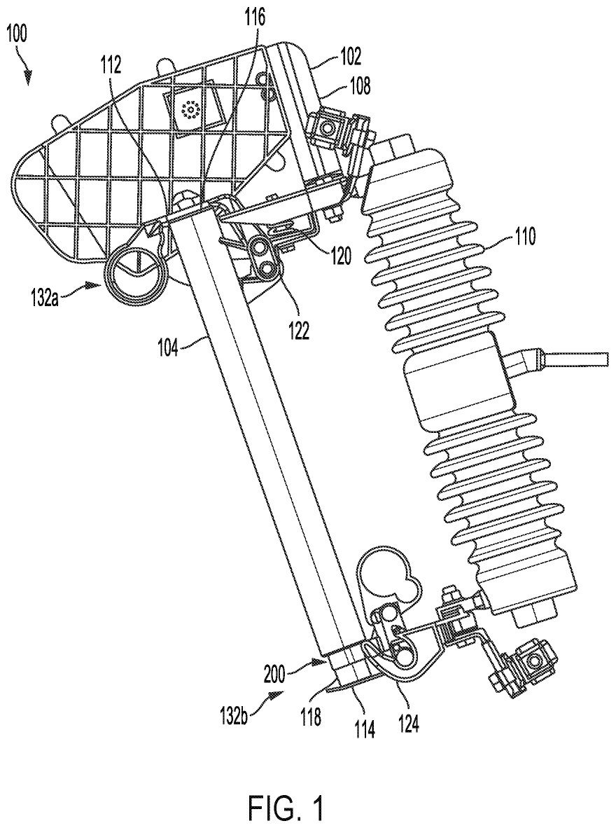

FIG. 1 is a perspective view illustrating a system 100, according to some embodiments. FIG. 1 illustrates a side view of an exemplary embodiment of a fuse cutout assembly 102 utilizing a fuse assembly 104 having a fuse release 200 according to an illustrated embodiment of the present application. The fuse cutout assembly 102 can be utilized, for example, in connection with providing protection from at least current surges and overloads in high and medium voltage electric utility services, including, but not limited to, in electrical transmission systems and distribution systems operating at nominal voltages of about 3 kilovolts (kV) to about 38 kV, among other voltages and voltage ranges.

In addition to the fuse assembly 104, the fuse cutout assembly 102 can include a cutout body 108 that supports the fuse assembly 104, and to which an insulator 110 is attached. The cutout body 108 can include an upper contact 112 and a lower contact 114 at opposing ends of the cutout body 108 that are positioned to be electrically coupled to a first contact 116 and a second contact 118, respectively, of the fuse assembly 104. The upper contact 112 may be biased by a biasing element 120, such as, for example, a spring, so as to provide a biasing force that at least attempts to maintain an engagement between the upper contact 112 of the cutout body 108 and the first contact 116 of the fuse assembly 104.

The fuse release 200 may be installed onto the end of the fuse cutout assembly 102 at the second contact 118, such that the fuse release 200 is in electrical engagement with the second contact 118. In addition, the lower contact 114 may maintain an engagement with the second contact 118 of the fuse assembly 104 by the fuse release 200, that is, the lower contact 114 may contact the fuse release 200 installed onto the second contact 118 of the fuse assembly 104. The lower contact 114 may be attached to the fuse release 200 by a fastener, that is, the fuse release 200 may include a threaded bore extending, at least in part, in the fuse release 200 and the fastener may include one or more threads that engages the threads in the bore and attaches the lower contact 114 onto the fuse release 200, as will be further described herein. In this regard, when the fuse assembly 104 and the fuse release 200 are installed into the fuse cutout assembly 102, the fuse release 200 may be configured to place the fuse assembly 104 in electrical engagement with the fuse cutout assembly 102.

The cutout body 108 can also include an upper hinge or bracket 122 and a lower bracket or hinge 124 at opposite ends of the cutout body 108. The bracket 122 may be located at an upper end 132a of the cutout body 108 and pivotably coupled to the upper contact 112. The hinge 124 may be located at a lower end 132b of the cutout body 108 and pivotably coupled to the lower contact 114. The lower bracket or hinge 124 of the cutout body 108 can be configured to accommodate pivotal displacement of the fuse assembly 104 about the cutout body 108 as the fuse release 200 causes the displacement of the lower contact 114, thereby interrupting the electrical engagement of the fuse assembly 104 with the upper contact 112 of the cutout body 108.

As seen in FIG. 1, when the fuse assembly 104 is supported by the cutout body 108, and the first contact 116 of the fuse assembly 104 is electrically coupled to the upper contact 112 and the and the second contact 118 of the fuse assembly 104 is electrically coupled to the lower contact 114, the cutout body 108 may support the fuse assembly 104 at an angle. As discussed below, in the event of activation of fuse release 200, such as, for example, in response to a current surge or overload event, the fuse release 200 can exert a force onto the lower contact 114 in a manner that can cause the pivotable displacement of the lower contact 114 at the bracket or hinge 124, thereby enabling the pivotal displacement of fuse assembly 104 so as to facilitate physical and/or electrical disengagement between the first contact 116 of the fuse assembly 104 and the upper contact 112. In the event the fuse assembly 104 is to be disengaged from direct contact with the upper contact 112 of the cutout body 108, the angle at which the fuse assembly 104 is supported by the cutout body 108 can allow gravitational forces to at least assist in the fuse assembly 104 being pivotally displaced about the lower bracket or hinge 124 of the cutout body 108 such that the first contact 116 of the fuse assembly 104 is rotated away from the upper contact 112 of the cutout body 108. Such pivotal displacement can, according to at least some embodiments, be further facilitated by another biasing element (not shown) that can provide a biasing force that is transmitted generally to the lower end 132b of the fuse assembly 104 at lower bracket or hinge 124, and which at least assists in facilitating pivotal displacement of the fuse assembly 104 about the lower bracket or hinge 124.

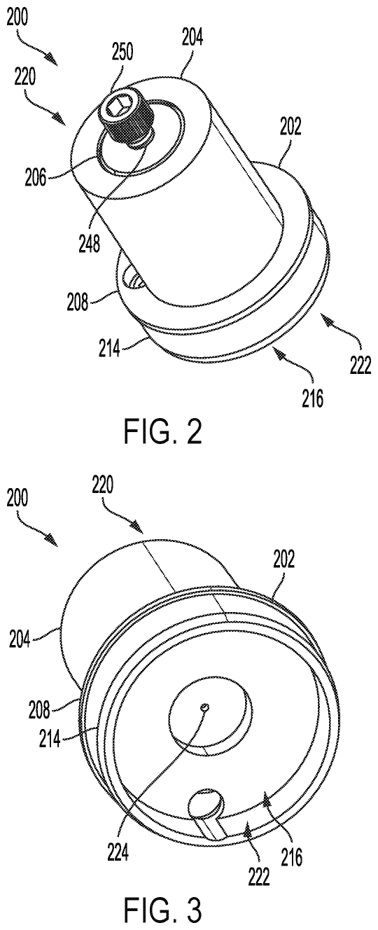

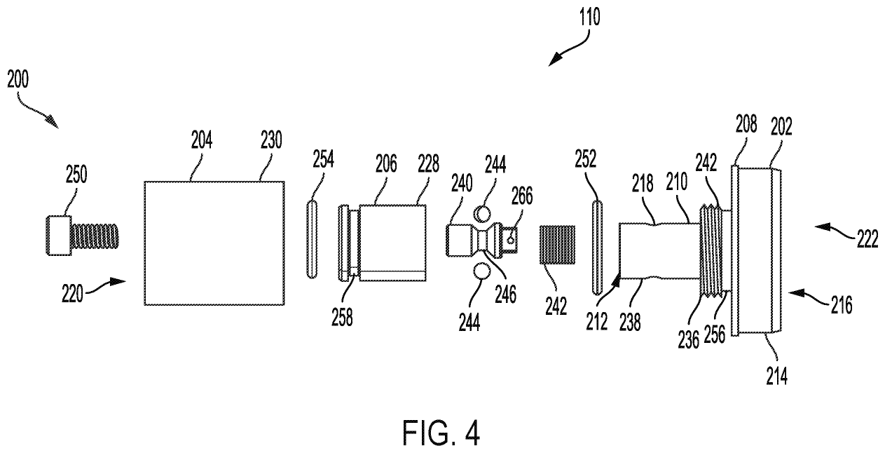

FIG. 2 is a first perspective view illustrating a fuse release 200 of FIG. 1, according to some embodiments. FIG. 3 is a second perspective view illustrating the fuse release 200 of FIG. 1, according to some embodiments. FIG. 4 is an exploded side view illustrating the fuse release 200 of FIG. 1, according to some embodiments. Unless specified otherwise, FIGS. 2-4 will be described collectively.

Fuse release 200 may be a device or apparatus including a cap 202, an adapter 204, and a release 206. The cap 202 may include a plate member 208, a first sidewall 210 (FIG. 4), and a second sidewall 214. The first sidewall 210 extends from the plate member 208 towards a first end 220, and the first sidewall 210 may define an interior region 212. The first sidewall 210 may include one or more first apertures 218 (FIG. 4) extending through the first sidewall 210. The second sidewall 214 extends from the plate member 208 towards a second end 222, and the second sidewall 214 may define a recess 216.

Referring to FIG. 3, the plate member 208 may include an aperture 224 extending therethrough. The aperture 224 may be configured to place the interior region 212 in fluid communication with the recess 216. The plate member 208 of cap 202 may also include a vent hole configured to place the recess 216 in fluid communication with an exterior of the fuse release 200.

The fuse release 200, as shown in FIG. 1, may be configured to be installed onto the fuse assembly 104 such that the second contact 118 of the fuse assembly 104 may be arranged in the recess 216. The recess 216 may be configured to receive an end of a fuse assembly 104 to place the fuse assembly 104 in electrical engagement with the fuse release 200. In this regard, the size and dimensions of the fuse release 200 and the recess 216 are not intended to be limiting and may vary based on the size and dimensions of the fuse assembly 104, the fuse cutout assembly 102, or both. The fuse release 200 may be configured to place the fuse assembly 104 in electrical engagement with the cutout body 108 when installed into the fuse cutout assembly 102.

Referring to FIG. 4, the interior region 212 of the cap 202 may be defined by one or more first sidewall 210. In some embodiments, the interior region 212 of the cap 202 may be defined by at least one first sidewall 210. In other embodiments, the interior region 212 of the cap 202 may be defined by a plurality of first sidewall 210. The recess 216 of the cap 202 may be defined by one or more second sidewall 214. In some embodiments, the recess 216 may be defined by at least one second sidewall 214. In other embodiments, the recess 216 may be defined by a plurality of second sidewall 214.

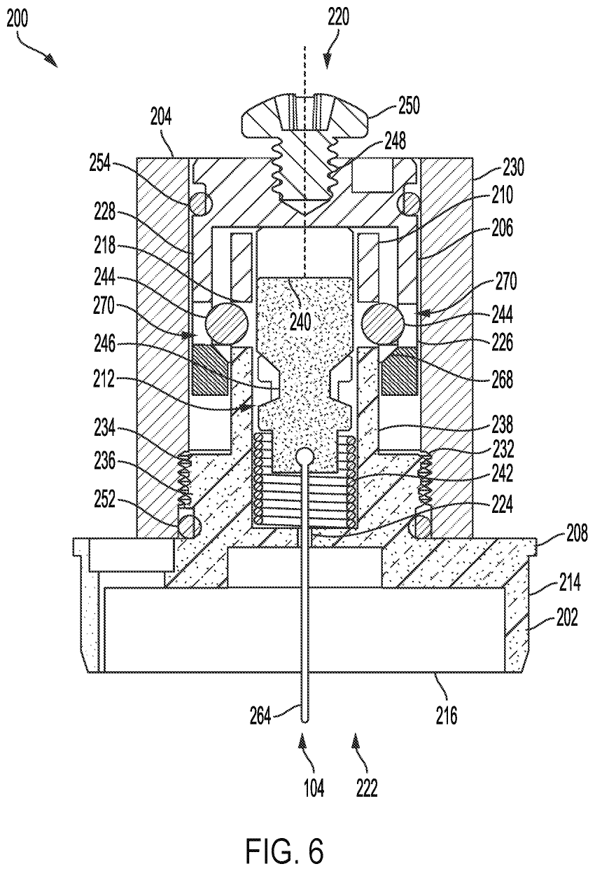

The release 206 may include a third sidewall 228. The third sidewall 228 may include second apertures 226 (as shown in FIG. 6). In some embodiments, the third sidewall 228 may include one or more second apertures 226. In other embodiments, the third sidewall 228 may include a plurality of second apertures 226. The release 206 may be configured to, in a first position, be arranged between the at least one first sidewall 210 and the adapter 204 such that the one or more first apertures 218 are in colinearly alignment with the one or more second apertures 226. That is, in the first position, each of the first apertures 218 may be in colinearly alignment with a corresponding one of the second apertures 226 to define regions that may be in communication with the interior region 212.

The adapter 204 may include a fourth sidewall 230. The adapter 204 may be installed into fuse release 200 such that the adapter 204 may be arranged around the first sidewall 210 and the third sidewall 228. The fourth sidewall 230 may include one or more threads 232 (FIG. 6) disposed on an inner surface of the adapter 204, the one or more threads 232 of the adapter 204 being configured to engage one or more threads 234 located on an exterior surface of the first sidewall 210 to enable the adapter 204 to retain its position around the first sidewall 210 of the cap 202 and the release 206.

The first sidewall 210 may include a first portion 236 having a first outer diameter and a second portion 238 having a second outer diameter. In some embodiments, the first outer diameter may be greater than the second outer diameter. In other embodiments, the first outer diameter may be substantially equal to the second outer diameter. The first portion 236 may be arranged between the plate member 208 and the second portion 238, that is, the first portion 236 may define a step, the step including the one or more threads 234. In addition, the fourth sidewall 230 of the adapter 204 may define an inner diameter corresponding to the second outer diameter of the first portion 236 to enable the adapter 204 to be attached to the cap 202. The stepped profile of the first sidewall 210 also enables the accommodation of the third sidewall 228 of the release 206 between the first sidewall 210 and the fourth sidewall 230.

The fuse release 200 may include a trigger 240, a biasing element 242, and retention bodies 244. The trigger 240 and the biasing element 242 may be arranged in the interior region 212, with the biasing element 242 being arranged between the trigger 240 and the plate member 208 in the interior region 212. The biasing element 242 may be configured to move the trigger between a locked or tensioned position and an unlocked or released position such that the fuse release 200 may transition from the first or locked state to the second or unlocked state, as will be further described herein.

When in the locked state, the biasing element 242 may receive a tension or compressive force applied by the trigger 240 and/or the elongate member 264 (FIG. 6). In response to this force, the biasing element 242 may be in a compressed state, thereby enabling the biasing element 242 and trigger 240 to be positioned in the interior region 212. As a result, the release 206 may then be positioned such that the second apertures 226 colinearly align with the first apertures 218 such that the retention bodies 244 may be positioned in the region defined by the first apertures 218 and second apertures 226.

The trigger 240 may include a recessed portion 246. The recessed portion 246 may be circumferentially extending along an intermediate portion of the trigger 240. The recessed portion 246 may be configured to enable the retention bodies 244 to be positioned, at least in part, in the interior region 212 to enable the trigger 240 to engage and move the release, as will be further described herein. In some embodiments, the trigger 240 may include a single recessed portion 246 circumferentially extending around an intermediate portion of the body of the recessed portion 246. In other embodiments, the trigger 240 may include one or more recessed portions 246 circumferentially positioned around the intermediate portion of the body of the recessed portion 246.

The recessed portion 246 may be configured to enable the retention bodies 244 to be positioned, at least in part, in the interior region 212 of the cap 202 to enable the trigger 240 to engage and move the release 206 outward in an axial direction. That is, when the fuse assembly 104 and the fuse release 200 are installed in the fuse cutout assembly 102 as shown in FIG. 1, the fuse release 200 may be triggered in response to a surge or overcurrent event that causes the release 206 to extend outward in the axial direction, thereby enabling the fuse release 200 to trigger the lower contact 114 of the lower bracket or hinge 124 to cause the pivotal displacement of the fuse assembly 104 from electrical engagement with the fuse cutout assembly 102.

The retention bodies 244 may be configured to be positioned, by the trigger 240, in the region 270 defined by the first apertures 218 and second apertures 226 when they are in colinearly alignment. The retention bodies 244 may help retain the release 206 in a fixed position relative the longitudinal axis of the fuse release 200 when in the locked state. In some embodiments, the fuse release 200 may include a plurality of the retention bodies 244. For example, the fuse release 200 may include three first apertures 218 spaced equidistant around a circumference of the first sidewall 210 of cap 202, three corresponding second apertures 226 circumferentially arranged on the release 206, and three corresponding retention bodies 244 configured to be arranged therein. It is to be appreciated by those having skill in the art that the number of retention bodies 244 installed into the fuse release 200 is not intended to be limiting and is also not intended to be limited based on the number of first apertures 218 and second apertures 226. That is, the number of retention bodies 244 installed in the fuse release 200 may be adequate to enable retaining the release 206 in the fixed position when the fuse release 200 is in the locked state, and not necessarily based on the number of first apertures 218 and second apertures 226 in the fuse release 200. For example, the fuse release 200 may include three first apertures 218 and three corresponding second apertures 226 and only include two retention bodies 244.

The release 206 may include a threaded bore 248 located at the first end 220, the threaded bore 248 extending into the release 206, or a portion thereof, towards the second end 222. The threaded bore 248 may be configured to receive a fastener such as fastener 250 as shown in FIG. 2. The fastener 250 may be configured to attach the lower contact 114 of the lower bracket or hinge 124 (e.g., by installing fastener 250 through a slot or aperture on the lower contact 114) and threading the fastener 250 into the threaded bore 248 of fuse release 200 such that the triggering of the fuse release 200 causes the pivotal displacement of lower contact 114 and the electrical disengagement of the fuse assembly 104 from the fuse cutout assembly 102.

The fuse release 200 may also include ring 252 and ring 254. Ring 252 may be located around the exterior of the first sidewall 210 adjacent the base of plate member 208. When the adapter 204 is fully installed onto cap 202 such that the one or more threads 232 of adapter 204 fully engages the one or more threads 234 of the first sidewall 210, the ring 252 may be configured to contact respective opposing surfaces of cap 202 and adapter 204 such that the ring 252 seals the connection point from intrusion of fluids such as water. The first sidewall 210 may include a channel 256 circumferentially extending around the first sidewall 210, the channel 256 being configured to receive the ring 252 for sealing the connection point between the cap 202 and the adapter 204 at the base of plate member 208.

Ring 254 may be located around release 206. When the release 206 is fully seated onto the first sidewall 210 such that the first apertures 218 are in colinearly alignment with the second apertures 226, the ring 254 may be configured to contact respective opposing surfaces of the adapter 204 and release 206 such that the ring 254 provides a sealed connection point between the adapter 204 and release 206 from intrusion of fluids such as water. The release 206 may include a channel 258 circumferentially extending around the third sidewall 228 of the release 206, the channel 258 being configured to receive ring 254 for sealing the connection point between the adapter 204 and release 206 adjacent the first end 220.

In some embodiments, the ring 252 and ring 254 may be an O-ring configured to provide a seal at the respective connection points between the cap 202 and adapter 204 and between the adapter 204 and release 206. The ring 252 and ring 254 may be made of any of a plurality of materials including, but not limited to, silicone, rubber, nitrile rubber, thermoplastics, neoprene, Ethylene, Fluorocarbon, Polyurethane, Polytetrafluoroethylene (“PTFE”), other like materials, or any combinations thereof.

It is to be appreciated by those having ordinary skill in the art that the sizes and dimensions of the fuse release 200 are not intended to be limiting and may depend on any of a plurality of factors including, but not limited to, the sizes and dimensions of the fuse assembly 104, fuse cutout assembly 102, the location where the fuse assembly 104 is being installed, other like factors, or any combinations thereof.

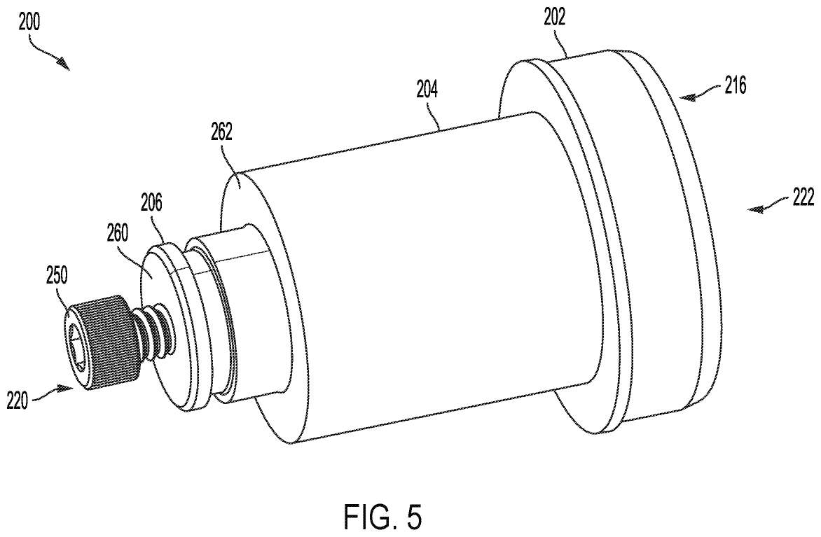

FIG. 5 is a side perspective view illustrating the fuse release 200, according to some embodiments.

The fuse release 200 may be configured to transition between a first state as shown, for example, in FIG. 2, and a second state. When installed onto the fuse assembly 104, the fuse release 200 being in the second state may be indicative of a fault condition in the system in electrical connection with the fuse assembly 104. The fuse release 200 may be in the first state during a normal operating condition of fuse assembly 104, that is, a tension force may be applied to the trigger 240 (such as by elongate member 264 in FIG. 6), thereby causing the trigger 240 to compress the biasing element 242 in the axial direction towards the second end 222. Trigger 240 moving towards the second end 222 thereby applies a compressive force onto biasing element 242 to enable the release 206 body to be installed around the first sidewall 210 and positioned in a first state. In the first state, as shown in FIG. 2, the release 206 may be positioned relative the cap 202 such that the first apertures 218 may be placed in colinearly alignment with the second apertures 226.

In some embodiments, in the first state, release 206 may also be positioned relative adapter 204 such that surface 260 of release 206 may be on a same plane as surface 262 of adapter 204. In other embodiments, in the first state, the release 206 may also be positioned relative adapter 204 such that surface 260 of release 206 may be on a different plane as surface 262 of adapter 204. For example, in some embodiments, the surface 260 of release 206 may be recessed relative surface 262. In other embodiments, the surface 260 of release 206 may protrude relative surface 262.

As shown in FIG. 5, when there is a surge or overcurrent event in the electrical circuit that includes the fuse assembly 104 and fuse release 200 installed therein, the surge or overcurrent event may cause the conductive element in the fuse assembly 104 to melt, thereby causing the fuse release 200 to transition from the first state to the second state. That is, the melting of the conductive element may mechanically disconnect the fuse assembly 104 from the trigger 240 of the fuse release 200, thereby releasing the tension force applied to trigger 240 and releasing the compressive force being applied onto biasing element 242 by trigger 240. In response, the biasing element 242 may apply the spring force of biasing element 242 between the plate member 208 and trigger 240, such that the opposite end of trigger 240 translates the spring force onto release 206 and causes trigger 240 and release 206 to move in the axial direction towards the first end 220 and away from the second end 222. That is, the biasing element 242 may eject the release 206 from its position in the first state and slidingly moves the release 206 in the axial direction such that the release 206 extends from surface 262 by a certain distance. In this regard, the distance by which the surface 260 of release 206 extends from the surface 262 of plate member 208 may be dependent on the configuration and design of the components of the fuse release 200 including, but not limited to, biasing element 242 and the spring force applied by the biasing element 242 to the release 206 via the trigger 240.

FIG. 6 is a side sectional view illustrating the fuse release 200, according to some embodiments.

When the fuse release 200 is installed onto the fuse assembly 104, an elongate member 264 may be connected to the conductive element in fuse assembly 104 at one end and may be attached to the trigger 240 at the other end of elongate member 264, the elongate member 264 being configured to mechanically couple the trigger 240 to the conductive element. The elongate member 264 may also be tensioned to apply the tension force to the trigger 240 such that the trigger 240 is placed into the locked or tensioned position and the biasing element 242 is compressed by the trigger 240.

The elongate member 264 may be connected to the trigger 240 by any of a plurality of connection methods. In some embodiments, the trigger 240 may include a bore 266 extending through trigger 240, and the elongate member 264 may extend through bore 266 and attach the elongate member 264 to the trigger 240. For example, the elongate member 264 may be tied onto an end of the trigger 240. In other embodiments, the elongate member 264 may be attached to trigger 240 by any of a plurality of other means including, but not limited to, by welding, solder, screws, rivets, clips, glues, clamps, sealants, epoxies, other types of fasteners, or any combinations thereof.

The elongate member 264 may also be referred to as a connective member, connective element, filament, wire, etc. The elongate member 264 may mechanically couple the fuse assembly 104 to the fuse release 200, the elongate member 264 extending between and attaching to the conductive element in the fuse assembly 104 at one end and the elongate member 264 being attached to a portion of the trigger 240 at the opposite end of the elongate member 264. During an installation of the fuse assembly 104 to the fuse release 200, the elongate member 264 may be tensioned such as to place the fuse release 200 and its one or more components into the first or locked state. In addition, the elongate member 264 may be made of a material having a certain tensile strength capable of withstanding the tension force that may be applied to the elongate member 264 to place the fuse release 200 in the first state. In some embodiments, the elongate member 264 may both mechanically couple and electrically connect the fuse assembly 104 with the fuse release 200. In this regard, the elongate member 264 may be made of an electrically conductive material having the certain tensile strength capable of withstanding the tension force that may be applied to the elongate member 264 to place the fuse release 200 in the first state.

In the first state, the elongate member 264 may apply a tension force to the attached trigger 240, to place trigger 240 in the locked or tensioned position. In the locked position, the trigger 240 compresses the biasing element 242 located in the interior region 212 between the trigger 240 and a bottom of the interior region 212 such that the trigger 240 is positioned within the interior region 212 as defined by the first sidewall 210. In the locked position, an outer dimension or external side surface of trigger 240 may engage the retention bodies 244 that may be arranged in the regions 270 defined by the first apertures 218 and the second apertures 226, the retention bodies 244 being positioned in the regions 270 to enable the release 206 to be retained in the first position by the retention bodies 244.

In response to a surge or overcurrent condition, the conductive element of fuse assembly 104 may melt or some other reaction may occur in the fuse assembly 104, thereby causing the trigger 240 to become mechanically (and/or electrically) decoupled or disconnected from the conductive element in the fuse assembly 104 via the elongate member 264. In addition, by mechanically decoupling or disconnecting trigger 240 from the conductive element in the fuse assembly 104, the tension force applied by elongate member 264 may be removed, thereby enabling the biasing element 242 to apply the spring force onto trigger 240 and to cause the trigger 240 to move to the unlocked or released position. When transitioning from the locked position to the unlocked position, biasing element 242 applies the spring force onto trigger 240 such that an end of trigger 240 located opposite biasing element 242 engages an interior surface of release 206 to cause the release 206 to move to the second extended position as the trigger 240 moves to the unlocked position.

The release 206 may include, on an inner surface of the third sidewall 228, a flange portion 268. As the release 206 moves to the second extended position in response to the trigger 240 moving to the unlocked or released position and thereby engaging the release 206, the flange portion 268 on the inner surface of the release 206 may engage the retention bodies 244 to promote the translation of their respective positions from the regions 270 defined by the first apertures 218 and the second apertures 226 and into, at least in part, the interior region 212 such that the retention bodies 244 do not prevent the movement of release 206 in the axial direction towards the first end 220 and to the second position by the trigger 240 as the trigger 240 moves to the unlocked or released position.

The trigger 240 may include the recessed portion 246. In some embodiments, the recessed portion 246 may circumferentially extend along an intermediate portion of the trigger 240. In addition, the recessed portion 246 may be configured to enable the retention bodies 244 to be positioned, at least in part, in the interior region 212 at the recessed portion 246 to enable the trigger 240 to engage and move the release 206 in the axial direction to the second position. That is, as the trigger 240 and release 206 move in the axial direction towards the first end 220, the flange portion 268 may promote the translation of the retention bodies 244 from regions 270 to the interior region 212 and the recessed portion 246 such that the retention bodies 244 may, at least in part, be positioned in the interior region 212 and recessed portion 246 to enable the trigger 240 to move the release 206 to the second position.

In some embodiments, the elongate member 264 may be a filament or wire filament that mechanically couples the conductive element in the fuse assembly 104 with the trigger 240. The elongate member 264 may be configured to be attached to trigger 240 to mechanically couple the trigger 240 to a conductive element in the fuse assembly 104. The elongate member 264 may also retain a position of the trigger 240 in the locked or tensioned position when the filament is intact or when the conductive element in the fuse assembly 104 remains attached to the filament. In addition, in response to the filament mechanically decoupling from the conductive element in the fuse assembly 104, the trigger 240 is also mechanically decoupled from the conductive element, thereby enabling the biasing element 242 to apply the biasing or spring force onto the trigger 240 and to translate or move the trigger 240 from the locked or tensioned position to the unlocked or released position. In some embodiments, in response to the spring force exerted by the biasing element 242, a portion of the trigger 240 may be located in an exterior region external to the interior region 212 defined by the first sidewall 210. In other embodiments, in response to the spring force exerted by the biasing element 242, a substantial portion of the trigger 240 may be located in the exterior region. In yet other embodiments, a portion of the biasing element 242 may also be located in the exterior region such that at least a portion of the trigger 240 is located in the exterior region.

The fuse release 200 utilizes the stored mechanical energy of the biasing element 242 provided as a result of applying tension to the trigger 240 using the elongate member 264 to propel the trigger 240 and the release 206 in the outward axial direction towards the first end 220 to disclose the fuse assembly 104 from the fuse cutout assembly 102 when there is a surge event, overcurrent event, or some other event that mechanically decouples the fuse release 200 from the fuse assembly 104. In this regard, the biasing element 242 may be a spring element that may be held in compression by the elongate member 264.

The one or more embodiments of the present disclosure only necessitate a single biasing element 242 to initiate the fuse indication, to enable the fuse release 200 to act in cooperation with the fuse cutout assembly 102 (and other external forces) to eject the fuse assembly 104 from electrical engagement with the upper contact 112. It is to be appreciated by those having ordinary skill in the art that the size and dimensions of the fuse release 200 as described herein may be configured to enable the fuse release 200 to be utilized in certain applications that may not be suitable for conventional fuse releases of the prior art due to their larger size and dimensions and/or based on their distinct method of operation. Conventional fuse releases may utilize a combustible medium to trigger the internal components of the fuse release, while certain other conventional fuse releases may utilize multiple spring elements to initiate the fuse indication, thereby resulting in the fuse release having a larger overall size to accommodate the additional components as compared to the fuse release 200 as described herein.

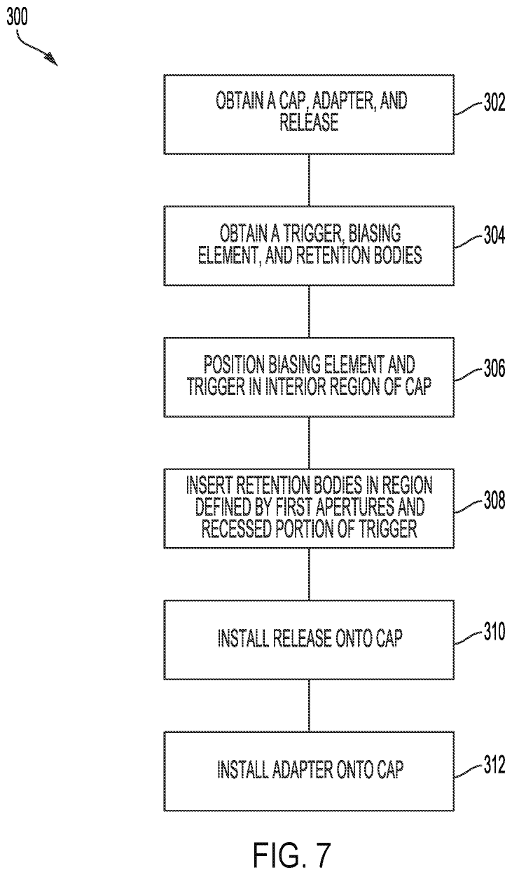

FIG. 7 is a flow diagram of a method 300 for manufacturing a fuse release 200, according to some embodiments.

At 302, the method 300 includes obtaining a cap 202, an adapter 204, and a release 206. The cap 202 includes a plate member 208, a first sidewall 210 defining an interior region 212, and a second sidewall 214 defining a recess 216. The first sidewall 210 extends from the plate member 208 towards a first end 220. In addition, the second sidewall 214 extends from an opposite side of the plate member 208 and towards a second end 222 opposite the first end 220. In some embodiments, the first sidewall 210 may include one or more first sidewall 210, and the second sidewall 214 may include one or more second sidewall 214.

The first sidewall 210 may include first apertures 218 extending therethrough. In some embodiments, the fuse release 200 may include one or more first apertures 218 extending through the first sidewall 210. In other embodiments, the fuse release 200 may include a plurality of the first apertures 218 extending through the first sidewall 210. In addition, the first apertures 218 may be spaced apart in the circumferential direction along the first sidewall 210. For example, the spacing of the first apertures 218 along the circumferential direction on the first sidewall 210 may be substantially equidistant.

The third sidewall 228 of the release 206 may include second apertures 226 extending therethrough. In some embodiments, the release 206 may include a plurality of the second apertures 226 extending through the third sidewall 228. The third sidewall 228 may also be spaced apart in the circumferential direction along the third sidewall 228 such that when the release 206 is in the first position, the second apertures 226 may be in colinear alignment with a corresponding first apertures 218 on the first sidewall 210.

At 304, the method 300 includes obtaining a trigger 240, a biasing element 242, and retention bodies 244. The trigger 240 may have a cylindrically shaped body configured to be inserted into the interior region 212. The trigger 240 may also include a recessed portion 246 located along an intermediate portion of the trigger 240 body. The recessed portion 246 may, in some embodiments, extend around the trigger 240 body in the circumferential direction such that the recessed portion 246 has a smaller diameter than a head of the trigger 240 that may be configured to engage the release 206. In addition, in some embodiments, the biasing element 242 may be a cylindrically shaped spring element configured to be inserted into the interior region 212.

At 306, the method 300 includes positioning the biasing element 242 and the trigger 240 in the interior region 212, the biasing element 242 being located between the trigger 240 and the plate member 208. The biasing element 242 being disposed between the plate member 208 and trigger 240 enables the tension force applied to the trigger 240 to compress the biasing element 242, and the enable the biasing element 242 to apply the spring force between the plate member 208 and the trigger 240 when the tension force being applied by an elongate member 264 to the trigger 240 is removed.

At 308, the method 300 includes inserting the retention bodies 244 in a region 270 defined by the first apertures 218 in the first sidewall 210 and the recessed portion 246 of the trigger 240. To align the recessed portion 246 with the first apertures 218 to enable the retention bodies 244 to be inserted therein, the trigger 240 may be compressed onto the biasing element 242 and/or rotated about its axis in the interior region 212 to align the recessed portion 246 of the trigger 240 body with the first apertures 218. In addition, when the recessed portion 246 are aligned with the first apertures 218 such as to accommodate the retention bodies 244 in a corresponding region, the entire body of the retention bodies 244 may be located in the region such that no portion of the retention bodies 244 protrudes from an exterior surface of the first sidewall 210 to enable the release 206 to be installed onto the first sidewall 210 of the cap 202.

At 310, the method 300 includes installing the release 206 onto the cap 202 such that the third sidewall 228 of the release 206 is located around the first sidewall 210. The release 206 may be inserted onto the first sidewall 210 until the release 206 is in the first position such that an inner surface of the release 206 contacts the edge of the first sidewall 210.

At 312, the method 300 includes installing the adapter 204 onto the cap 202. The adapter 204 may include one or more threads on an inner surface of the fourth sidewall 230 of the adapter 204. In addition, the first sidewall 210 may include one or more threads located adjacent the plate member 208, the one or more threads of the adapter 204 being configured to engage the one or more threads of the first sidewall 210. In some embodiments, the first sidewall 210 may include a first portion 236 having a first diameter and a second portion 238 having a second diameter, the first diameter being greater than the second diameter. The one or more threads on the first sidewall 210 may be located on the first portion 236 and the adapter 204 may engage these threads on the first portion 236 to be installed onto the cap 202, the difference in diameter between the first diameter and the second diameter being configured to accommodate the third sidewall 228 of the release 206 therebetween.

In some embodiments, the method 300 may include attaching an elongate member 264 to an end of the trigger 240, the elongate member 264 being configured to be mechanically coupled between the trigger 240 and a conductive element of a fuse assembly 104. In addition, in some embodiments, the method 300 may include applying, with the elongate member 264, a tension force onto the trigger 240 when the trigger 240 and biasing element 242 are located in the interior region 212 such as to compress the biasing element 242 and to generate a stored energy potential in the biasing element 242. The elongate member 264 may be attached to the trigger 240 and the conductive element with this tension force being applied to the trigger 240, such that a surge or overcurrent event occurring in an electrical circuit having the fuse assembly 104 and fuse release 200 installed therein can sever the connection between the conductive element and the elongate member 264 may cause the triggering of the fuse release 200 to eject the fuse assembly 104 from the fuse cutout assembly 102.

In some embodiments, the trigger 240 may have an outer profile such as shown in FIG. 6, such that as the tension force applied to the trigger 240 using the elongate member 264 causes the trigger 240 to compress the biasing element 242 and moves the trigger 240 in the axial direction towards the second end 222, the profile defined by the trigger 240 and the recessed portion 246 may then engage the retention bodies 244, thereby causing them to be positioned in the regions 270 defined by the corresponding first apertures 218 and second apertures 226. The retention bodies 244 being positioned in the regions 270 thereby enables and/or facilitates the release 206 to be retained in the first position when the fuse release 200 is in the first state and the trigger 240 is in the locked or tensioned position.

In some embodiments, the method 300 may include installing a ring 252 and a ring 254 in the fuse release 200. The ring 252 may be installed at a base of the first sidewall 210 near the plate member 208 to provide a sealed connection point between the first sidewall 210 and fourth sidewall 230 when installing the adapter 204. In some embodiments, the first sidewall 210 may include a channel 256 to receive the ring 252. The ring 254 may be installed on the release 206 adjacent the first end 220 to provide a sealed connection point between the third sidewall 228 and fourth sidewall 230 when installing the adapter 204. In some embodiments, the third sidewall 228 may include a channel 258 to receive the ring 254.

In some embodiments, the method 300 may include installing the fuse release 200 onto a fuse assembly such as, for example, fuse assembly 104 such that the elongate member 264 mechanically couples the fuse release 200 (trigger 240) to the fuse assembly 104 (conductive element), and the elongate member 264 applies the tension force onto the trigger 240. The fuse assembly 104 may be installed into the recess 216 such that one of the contacts of the fuse assembly 104 is located therein, and the elongate member 264 may extend from the conductive element in the fuse assembly 104, through an aperture 224 extending through the plate member 208 and mechanically coupled to the trigger 240.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or
any combination(s) thereof.

### ASPECTS

Various Aspects are described below. It is to be understood that any one or more of the features recited in the following Aspect(s) can be combined with any one or more other Aspect(s).

Aspect 1. A fuse release assembly comprising: a cap comprising: a plate member, at least one first sidewall defining an interior region, and a plurality of first apertures extending through the at least one first sidewall; an adapter; a release comprising: a plurality of second apertures extending therethrough; a trigger; a biasing element; a plurality of retention bodies; and wherein the fuse release assembly is configured to transition between a locked state and an unlocked state, wherein, in the locked state, the release is arranged between the adapter and the at least one first sidewall such that the plurality of first apertures are in colinear alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position.

Aspect 2. The fuse release assembly according to aspect 1, wherein, during the transition from the locked state to the unlocked state, the biasing element provides a spring force onto the trigger and onto the release to enable the release to move from the first position to a second position, wherein the trigger and the biasing element being configured to apply the spring force onto the release such that a flange portion of the release engages the plurality of retention bodies and translates their position from the regions and into, at least in part, the interior region such that the release moves to the second position and enables at least a portion of the trigger to translate from the interior region to an exterior region.

Aspect 3. The fuse release assembly according to aspect 2, wherein the trigger comprises: at least one recessed portion, wherein the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position.

Aspect 4. The fuse release assembly according to any of the preceding aspects, wherein the cap further comprises: at least one second sidewall, wherein the at least one second sidewall is located opposite the plate member relative the at least one first sidewall and defines a recess, the recess being configured to receive a fuse assembly such that the fuse release assembly, when installed into a fuse cutout assembly with the fuse assembly, places the fuse assembly in electrical engagement with the fuse cutout assembly.

Aspect 5. The fuse release assembly according to aspect 4, wherein, when installed in a lower hinge bracket of the fuse cutout assembly, the fuse release assembly transitioning to the unlocked state triggers the lower hinge bracket to pivotably displace the fuse release assembly and the fuse assembly to electrically disengage the fuse assembly from the fuse cutout assembly.

Aspect 6. The fuse release assembly according to aspects 4 or 5, wherein the cap further comprises: an aperture, wherein the aperture extends through the plate member placing the interior region in fluid communication with the recess.

Aspect 7. The fuse release assembly according to aspect 6, further comprising: a filament, wherein the filament is configured to extend between the fuse assembly and the fuse release assembly through the aperture, the filament mechanically coupling a component in the fuse assembly to the trigger, wherein the filament is configured to retain the fuse release assembly in the locked state when the filament remains attached to the component in the fuse assembly, and wherein, in response to the filament mechanically decoupling from the component in the fuse assembly, enables the fuse release assembly to transition to the unlocked state.

Aspect 8. The fuse release assembly according to any of the preceding aspects, wherein the release comprises: at least one third sidewall, wherein the plurality of second apertures extend through the at least one third sidewall.

Aspect 9. The fuse release assembly according to any of the preceding aspects, wherein the adapter further comprises: at least one fourth sidewall, wherein the at least one fourth sidewall comprises one or more threads disposed on an inner surface of the adapter, the one or more threads being configured to engage one or more threads of the at least one first sidewall to retain the adapter in position around the at least one first sidewall and the release.

Aspect 10. A system comprising: a fuse assembly; a fuse release assembly comprising: a cap, a release, an adapter, a trigger, a biasing element, and a plurality of retention bodies; and a filament, wherein the filament extends between and mechanically couples a component of the fuse assembly to the trigger located in an interior region of the cap; wherein, in response to the filament mechanically decoupling the trigger from the component in the fuse assembly, the fuse release assembly is configured to transition from a locked state to an unlocked state and trigger a lower hinge bracket of a fuse cutout assembly to pivotably displace and electrically disengage the fuse assembly from the fuse cutout assembly.

Aspect 11. The system according to aspect 10, wherein the fuse cutout assembly comprises: an upper hinge bracket, and the lower hinge bracket; and wherein the fuse assembly is installed into the fuse cutout assembly between the upper hinge bracket and the lower hinge bracket, wherein the fuse release assembly is configured to be arranged in the lower hinge bracket between the fuse assembly and the fuse cutout assembly, the fuse release assembly being further configured to place the fuse assembly in electrical engagement with the fuse cutout assembly.

Aspect 12. The system according to aspects 10 or 11, wherein the cap comprises: a plate member, at least one first sidewall defining the interior region, at least one second sidewall defining a recess, and a plurality of first apertures extending through the at least one first sidewall; and wherein the release comprises: a plurality of second apertures, and a flange portion; wherein the trigger comprises: at least one recessed portion.

Aspect 13. The system according to aspect 12, wherein, in the locked state, the release is arranged between the adapter and the at least one first sidewall such that the plurality of first apertures are in colinearly alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position; wherein, during the transition from the locked state to the unlocked state, the biasing element provides a spring force onto the trigger and onto the release to enable the release to move from the first position to a second position, wherein the trigger and the biasing element being configured to apply the spring force onto the release such that the flange portion of the release engages the plurality of retention bodies and translates their position from the regions and into, at least in part, the interior region such that the release moves to the second position and enables at least a portion of the trigger to translate from the interior region to an exterior region.

Aspect 14. The system according to aspects 12 or 13, wherein the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position.

Aspect 15. The system according to aspects 12, 13, or 14, wherein the at least one first sidewall extends from the plate member and towards a first end to define the interior region; wherein the at least one second sidewall extends from the plate member and towards a second end to define the recess, the recess being configured to receive the fuse assembly; wherein the plate member further comprises an aperture placing the interior region in fluid communication with the recess.

Aspect 16. The system according to aspects 12, 13, 14, or 15, wherein the release comprises: at least one third sidewall, wherein the plurality of second apertures extends through the at least one third sidewall.

Aspect 17. The system according to aspects 12, 13, 14, 15, or 16, wherein the adapter further comprises: at least one fourth sidewall comprising one or more threads disposed on an inner surface of the adapter, wherein the one or more threads of the adapter are configured to engage one or more threads of the at least one first sidewall to retain the adapter in position around the at least one first sidewall and the release.

Aspect 18. A device comprising: a cap comprising: a plate member comprising an aperture extending therethrough, at least one first sidewall located on a first side of the plate member, the at least one first sidewall defining an interior region, a plurality of first apertures extending through the at least one first sidewall, and at least one second sidewall located opposite the plate member relative the at least one first sidewall, the at least one second sidewall defining a recess; an adapter; a release comprising: at least one third sidewall, and a plurality of second apertures extending through the at least one third sidewall; a trigger; a biasing element, wherein the biasing element is located between the plate member and the trigger; and a plurality of retention bodies; wherein the device is configured to transition between a locked state and an unlocked state, wherein, in the locked state, the release is arranged between the adapter and the at least one first sidewall such that the plurality of first apertures are in colinearly alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position, wherein, during the transition from the locked state to the unlocked state, the biasing element provides a spring force onto the trigger and onto the release to enable the release to move from the first position to a second position, wherein the trigger and the biasing element being configured to apply the spring force onto the release such that a flange portion of the release engages the plurality of retention bodies and translates their position from the regions and into, at least in part, the interior region such that the release moves to the second position and enables at least a portion of the trigger to translate from the interior region to an exterior region, to enable the device to electrically disengage a fuse assembly from a fuse cutout assembly.

Aspect 19. The device according to aspect 18, wherein the trigger comprises: at least one recessed portion, wherein the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position; wherein the adapter further comprises: at least one fourth sidewall, wherein the at least one fourth sidewall comprises one or more threads disposed on an inner surface of the adapter, the one or more threads of the adapter being configured to engage one or more threads of the at least one first sidewall to retain the adapter in position around the at least one first sidewall and the release.

Aspect 20. The device according to aspects 18 or 19, further comprising: a filament, wherein the filament is configured to extend between a component in the fuse assembly and the trigger through the aperture, the filament mechanically coupling the component in the fuse assembly to the trigger, wherein the filament is configured to retain the device in the locked state when the filament remains attached to the component in the fuse assembly, and wherein, in response to the filament mechanically decoupling from the component in the fuse assembly, enables the device to transition to the unlocked state and electrically disengage the fuse assembly from the fuse cutout assembly.

It is to be understood that changes may be made in detail, especially in matters of the construction materials employed and the shape, size, and arrangement of parts without departing from the scope of the present disclosure.

This Specification and the embodiments described are examples, with the true scope and spirit of the disclosure being indicated by the claims that follow.

What is claimed is:

1. A fuse release assembly comprising:
a cap comprising:
a plate member,
at least one first sidewall defining an interior region, and
a plurality of first apertures extending through the at least one first sidewall;
an adapter;
a release comprising:
a plurality of second apertures extending therethrough;
a trigger;
a biasing element;
a plurality of retention bodies; and
wherein the fuse release assembly is configured to transition between a locked state and an unlocked state,
wherein, in the locked state, the release is arranged between the adapter and the at least one first sidewall such that the plurality of first apertures are in colinear alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position.

2. The fuse release assembly of claim 1, wherein, during the transition from the locked state to the unlocked state, the biasing element provides a spring force onto the trigger and onto the release to enable the release to move from the first position to a second position, wherein the trigger and the biasing element being configured to apply the spring force onto the release such that a flange portion of the release engages the plurality of retention bodies and translates their position from the regions and into, at least in part, the interior region such that the release moves to the second position and enables at least a portion of the trigger to translate from the interior region to an exterior region.

3. The fuse release assembly of claim 2, wherein the trigger comprises:
at least one recessed portion,
wherein the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position.

4. The fuse release assembly of claim 1, wherein the cap further comprises:
at least one second sidewall,
wherein the at least one second sidewall is located opposite the plate member relative the at least one first sidewall and defines a recess, the recess being configured to receive a fuse assembly such that the fuse release assembly, when installed into a fuse cutout assembly with the fuse assembly, places the fuse assembly in electrical engagement with the fuse cutout assembly.

5. The fuse release assembly of claim 4, wherein, when installed in a lower hinge bracket of the fuse cutout assembly, the fuse release assembly transitioning to the unlocked state triggers the lower hinge bracket to pivotably displace the fuse release assembly and the fuse assembly to electrically disengage the fuse assembly from the fuse cutout assembly.

6. The fuse release assembly of claim 4, wherein the cap further comprises:
an aperture,
wherein the aperture extends through the plate member placing the interior region in fluid communication with the recess.

7. The fuse release assembly of claim 6, further comprising:
a filament,
wherein the filament is configured to extend between the fuse assembly and the fuse release assembly through the aperture, the filament mechanically coupling a component in the fuse assembly to the trigger,
wherein the filament is configured to retain the fuse release assembly in the locked state when the filament remains attached to the component in the fuse assembly, and wherein, in response to the filament mechanically decoupling from the component in the fuse assembly, enables the fuse release assembly to transition to the unlocked state.

8. The fuse release assembly of claim 1, wherein the release comprises:
at least one third sidewall,
wherein the plurality of second apertures extend through the at least one third sidewall.

9. The fuse release assembly of claim 1, wherein the adapter further comprises:
at least one fourth sidewall,
wherein the at least one fourth sidewall comprises one or more threads disposed on an inner surface of the adapter, the one or more threads being configured to engage one or more threads of the at least one first sidewall to retain the adapter in position around the at least one first sidewall and the release.

10. A system comprising:
a fuse assembly;
a fuse release assembly comprising:
a cap,
a release,
an adapter,
a trigger,
a biasing element, and
a plurality of retention bodies; and
a filament,
wherein the filament extends between and mechanically couples a component of the fuse assembly to the trigger located in an interior region of the cap;
wherein, in response to the filament mechanically decoupling the trigger from the component in the fuse assembly, the fuse release assembly is configured to transition from a locked state to an unlocked state and trigger a lower hinge bracket of a fuse cutout assembly to pivotably displace and electrically disengage the fuse assembly from the fuse cutout assembly.

11. The system of claim 10, wherein the fuse cutout assembly comprises:
an upper hinge bracket, and
the lower hinge bracket; and
wherein the fuse assembly is installed into the fuse cutout assembly between the upper hinge bracket and the lower hinge bracket,
wherein the fuse release assembly is configured to be arranged in the lower hinge bracket between the fuse assembly and the fuse cutout assembly, the fuse release assembly being further configured to place the fuse assembly in electrical engagement with the fuse cutout assembly.

12. The system of claim 10, wherein the cap comprises:
a plate member,
at least one first sidewall defining the interior region,
at least one second sidewall defining a recess, and
a plurality of first apertures extending through the at least one first sidewall; and
wherein the release comprises:
a plurality of second apertures, and
a flange portion;
wherein the trigger comprises:
at least one recessed portion.

13. The system of claim 12, wherein, in the locked state, the release is arranged between the adapter and the at least one first sidewall such that the plurality of first apertures are in colinearly alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position;
wherein, during the transition from the locked state to the unlocked state, the biasing element provides a spring force onto the trigger and onto the release to enable the release to move from the first position to a second position, wherein the trigger and the biasing element being configured to apply the spring force onto the release such that the flange portion of the release engages the plurality of retention bodies and translates their position from the regions and into, at least in part, the interior region such that the release moves to the second position and enables at least a portion of the trigger to translate from the interior region to an exterior region.

14. The system of claim 13, wherein the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position.

15. The system of claim 12, wherein the at least one first sidewall extends from the plate member and towards a first end to define the interior region;
wherein the at least one second sidewall extends from the plate member and towards a second end to define the recess, the recess being configured to receive the fuse assembly;
wherein the plate member further comprises an aperture placing the interior region in fluid communication with the recess.

16. The system of claim 12, wherein the release comprises:
at least one third sidewall,
wherein the plurality of second apertures extends through the at least one third sidewall.

17. The system of claim 12, wherein the adapter further comprises:
at least one fourth sidewall comprising one or more threads disposed on an inner surface of the adapter,
wherein the one or more threads of the adapter are configured to engage one or more threads of the at least one first sidewall to retain the adapter in position around the at least one first sidewall and the release.

18. A device comprising:
a cap comprising:
a plate member comprising an aperture extending therethrough,
at least one first sidewall located on a first side of the plate member, the at least one first sidewall defining an interior region,
a plurality of first apertures extending through the at least one first sidewall, and
at least one second sidewall located opposite the plate member relative the at least one first sidewall, the at least one second sidewall defining a recess;
an adapter;
a release comprising:
at least one third sidewall, and
a plurality of second apertures extending through the at least one third sidewall;
a trigger;
a biasing element,
wherein the biasing element is located between the plate member and the trigger; and
a plurality of retention bodies;
wherein the device is configured to transition between a locked state and an unlocked state,
wherein, in the locked state, the release is arranged between the adapter and the at least one first sidewall such that the plurality of first apertures are in colinearly alignment with the plurality of second apertures, the plurality of retention bodies are arranged in regions defined by the plurality of first apertures and the plurality of second apertures, and the trigger and the biasing element are arranged in the interior region such that the trigger engaging the plurality of retention bodies in the regions to retain the release in a first position,
wherein, during the transition from the locked state to the unlocked state, the biasing element provides a spring force onto the trigger and onto the release to enable the release to move from the first position to a second position, wherein the trigger and the biasing element being configured to apply the spring force onto the release such that a flange portion of the release engages the plurality of retention bodies and translates their position from the regions and into, at least in part, the interior region such that the release moves to the second position and enables at least a portion of the trigger to translate from the interior region to an exterior region, to enable the device to electrically disengage a fuse assembly from a fuse cutout assembly.

19. The device of claim 18, wherein the trigger comprises:
at least one recessed portion,
wherein the at least one recessed portion circumferentially extends along an intermediate portion of the trigger, the at least one recessed portion being configured to enable the plurality of retention bodies to be positioned, at least in part, in the interior region during the transition from the locked state to the unlocked state to enable the trigger and the biasing element to engage and translate the release to the second position;
wherein the adapter further comprises:
at least one fourth sidewall,
wherein the at least one fourth sidewall comprises one or more threads disposed on an inner surface of the adapter, the one or more threads of the adapter being configured to engage one or more threads of the at least one first sidewall to retain the adapter in position around the at least one first sidewall and the release.

20. The device of claim 18, further comprising:
a filament,
wherein the filament is configured to extend between a component in the fuse assembly and the trigger through the aperture, the filament mechanically coupling the component in the fuse assembly to the trigger,
wherein the filament is configured to retain the device in the locked state when the filament remains attached to the component in the fuse assembly, and wherein, in response to the filament mechanically decoupling from the component in the fuse assembly, enables the device to transition to the unlocked state and electrically disengage the fuse assembly from the fuse cutout assembly.
